(19) United States
(12) Patent Application Publication
(10) Pub. No.: US 2025/0037702 A1
(43) Pub. Date: Jan. 30, 2025

(54) ADAPTIVE PROSODY IN SIMULATED VOICE

(71) Applicant: International Business Machines Corporation, Armonk, NY (US)

(72) Inventors: Dirk Claas MICHELSEN, Hamburg (DE); John Michael Bouldin, Cedar Park, TX (US); Yun Zhai, Pound Ridge, NY (US)

(21) Appl. No.: 18/226,829

(22) Filed: Jul. 27, 2023

(51) Int. Cl. G10L 13/10; G10L 13/033; G10L 13/047; G10L 15/06; G10L 15/16; G10L 15/18; G10L 15/22

(52) U.S. Cl. CPC G10L 13/10; G10L 13/033; G10L 13/047; G10L 15/063; G10L 15/16; G10L 15/1815; G10L 15/22

(57) ABSTRACT

Systems and methods for real-time generation of adapted simulated voice are described. A processor can receive an audio input from a user. The processor can run a neural network using at least one property of the audio input to infer at least one audio parameter. The processor can generate a simulated voice using the at least one audio parameter. The processor can respond to the audio input using the simulated voice.

### BACKGROUND

The present application relates generally to computers and computer applications, and more particularly to automated agents, such as voicebots, for adapting a prosody of a simulated voice during natural language conversations with a user.

Interactive voice response (IVR) systems can interpret and respond to audio inputs, such as user queries. In an aspect, IVR systems can use natural language understanding (NLU) techniques to determine the meaning and intent of the user audio inputs. IVR systems can run an automated agent or program, such as a voicebot, that can conduct an audio conversation with a user in natural language. For example, the automated agent can answer the user's questions in the audio conversation via speech using a simulated voice.

### BRIEF SUMMARY

The summary of the disclosure is given to aid understanding of a computer system and method of adapting prosody in simulated voice being outputted by a voicebot during natural language conversations with a user. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

In one embodiment, a method for real-time generation of an adapted simulated voice for voicebot application is generally described. The method can include receiving, by a processor, an audio input from a user. The method can further include running, by the processor, a neural network using at least one property of the audio input to infer at least one audio parameter. The method can further include generating, by the processor, a simulated voice using the at least one audio parameter. The method can further include responding, by the processor, to the audio input using the simulated voice.

In one embodiment, a system for real-time generation of an adapted simulated voice for voicebot application is generally described. The system can include a memory configured to store a plurality of weights of a neural network. The system can further include a processor configured to receive an audio input from a user. The processor can further be configured to run the neural network using at least one property of the audio input to infer at least one audio parameter. The processor can further be configured to generate a simulated voice using the at least one audio parameter. The processor can further be configured to respond to the audio input using the simulated voice.

In one embodiment, a computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates an example computer or processing system or environment that may implement a system for adaptive prosody in simulated voice according to one embodiment.

FIG. 2 is a diagram illustrating a system that can implement adaptive prosody in simulated voice in one embodiment.

FIG. 3 is a diagram illustrating a system that can train a neural network for implementing adaptive prosody in simulated voice in one embodiment.

FIG. 4 is a diagram illustrating an inference process for adaptive prosody in simulated voice in one embodiment.

FIG. 5 is a diagram illustrating an example application that can use adaptive prosody in simulated voice in one embodiment.

FIG. 6 is a flow diagram illustrating a method of adaptive prosody in simulated voice in one embodiment.

FIG. 7 is another flow diagram illustrating a method of adaptive prosody in simulated voice in one embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

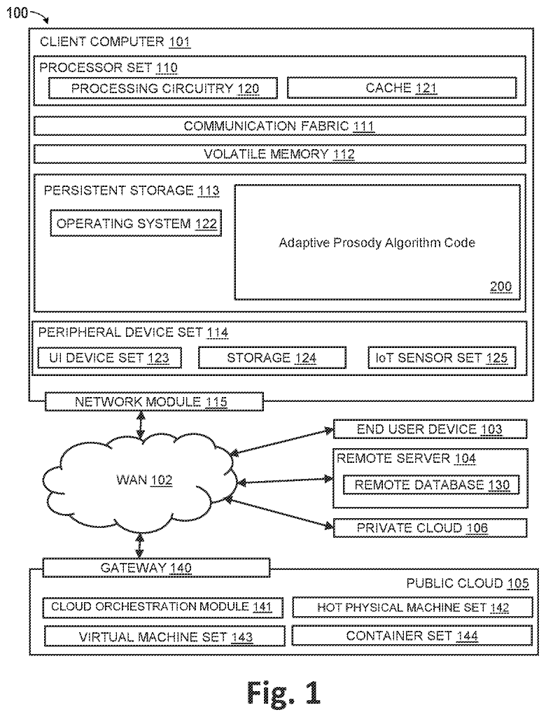

FIG. 1 illustrates an example computer or processing system or environment that may implement a system for adaptive prosody in simulated voice according to one embodiment. As shown in FIG. 1, computing environment 100 can include an example of an environment for the execution of at least some of the computer code involved in performing the inventive methods, such as an adaptive prosody algorithm code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Various applications that utilize voicebots disclosed herein can include, but are not limited to, digital assistants and virtual assistances for customer service, healthcare services, human resource, or other applications that utilizes a speech interface.

A challenge in voicebot applications is user acceptance. User acceptance can be, for example, a user's preference on the simulated voice being outputted by the voicebot. User acceptance or reception of voicebot simulated voices can vary among different types of users. For example, a user (or a speaker) may prefer a voicebot to output a simulated voice having lower pitch during conversations, while another user may prefer the voicebot to output another simulated voice that has higher pitch during conversations. Different simulated voices being outputted by voicebots can have different prosody, such as pitch, speed, pauses, and/or emergent description of the user that can be interpreted or estimated by the voicebot (or the processor running the voicebot) based on the measured properties of the speech of the user. The different simulated voices can also have different speech styles that can be associated with emotions, such as thankful, calm, angry, or other emotions.

In an aspect, modifying an entire simulated voice, or having to select a specific simulated voice from a plurality of simulated voices, may consume relatively more computational time and processing power. Voicebot applications can modify simulated voices by using speech synthesis markup language (SSML) or other markup languages. However, conventionally, this modification is performed prior to deploying the voicebot and these modifications are not made after deployment and/or during real-time use of the voicebot.

To improve users' simulated voice acceptance and reception in real-time, systems and methods described herein can train and use a neural network to produce different simulated voices based on a user in real-time. The neural network can facilitate modification of prosody and style of simulated voices to maximize user acceptance in real-time. The real-time modification can improve user voicebot experience and the effectiveness of voicebot applications. The neural network can receive user parameters (e.g., pitch, speed, pauses, and/or emergent properties) and other parameters (e.g., last uttering from the computer, last uttering from the user, current piece of text to be uttered, etc.) as inputs to modify prosody and styles such as pitch, speed, pauses, speech style and/or emergent properties that can be determined based on parameters of simulated voices.

In an aspect, an emergent property of a speech by a user or a speaker can be inferred by a computing system implementing the voicebot. The computing system can be trained to learn and identify emergent properties based on properties of the speech measured by the computing system. These properties that can be measured by the computing system can include, but not limited to, pitch, speed, pauses, volume, etc. Some examples of emergent properties of the speech or the user can include whether the speech/speaker can include whether the user seems patient or impatient, whether the user seems professional or formal, etc.

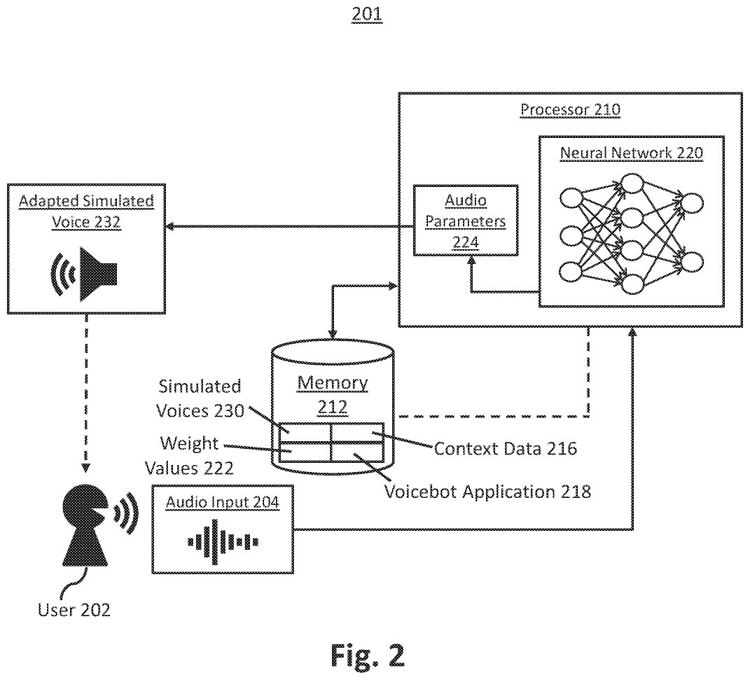

FIG. 2 is a diagram illustrating a system that can implement adaptive prosody in simulated voice in one embodiment. System 201 shown in FIG. 2 can be a computing system including at least a processor 210 and a memory 212. Processor 210 can be composed of at least one of microprocessors, microcontrollers, central processing units (CPU), single core processors, multi-core processors, other types of processors, and/or computing hardware composed of analog and/or digital circuitry. Memory 212 can be composed of at least one of volatile memory (e.g., random access memory (RAM) including static RAM and dynamic RAM, and/or other volatile memory (e.g., read only memory (ROM), erasable programmable ROM, and electrically erasable programmable ROM, and/or other non-volatile memory). Memory 212 can be configured to store data in digital form, and can be configured to store instructions as various forms of program code. Processor 210 can be configured to access and run program codes stored in memory 212 to perform various computer operations.

In one embodiment, memory 212 can be configured to store program code such as source code and/or executable code that can be accessed by processor 210 to run a voicebot application 218. Voicebot application 218 can be a computer program that can initiate and carry out a natural language conversation with one or more users. During operations of voicebot application 218, users can provide audio input to converse with voicebot application 218. Processor 210 can control voicebot application 218 to output simulated voices to respond to audio inputs provided by users, thus conducting a natural language conversation. In one embodiment, a plurality of simulated voices 230 can be stored in memory 212. The plurality of simulated voices 230 can include preset audio streams that can be selected, modified and outputted by processor 210 as simulated voices.

In one embodiment, during implementation of voicebot application 218, a user 202 can provide an audio input 204 to processor 210 via one or more interfaces configured to receive sound, such as a microphone connected to processor 210. Audio input 204 can be an analog signal encoding a speech of user 202. Processor 210 can receive audio input 204 as an analog signal and extract one or more properties of audio input 204. By way of example, properties that can be extracted by processor 210 can include one or more of pitch, speed, occurrences of pauses, frequency of pauses, uttering, and/or emergent properties, etc. Processor 210 can convert the extracted properties into digital data that can be inputted to a neural network 220. Neural network 220 can be, for example, an artificial neural network (ANN) such as a convolutional neural network (CNN), a feedforward neural network, a recurrent neural network, a multilayer perceptron, a deep network, or other types of ANN. A plurality of weight values 222 of neural network 220 can be stored in memory 212. Each one of weight values 222 can correspond to a feature, such as a specific prosody or style.

Neural network 220 can infer a result based on the properties extracted by processor 210, where the inferred result can be a plurality of audio parameters 224. Audio parameters 224 can represent prosody and styles, such as pitch, speed, pauses, speech style and/or emergent properties and parameters of simulated voices. Processor 210 can use the audio parameters 224 to generate an adapted simulated voice 232. In one embodiment, processor 210 can generate a new simulated voice using audio parameters outputted from neural network 220. In one embodiment, processor 210 can retrieve a simulated voice among simulated voices 230 stored in memory 212 and modify the retrieved simulated voice using audio parameters 224 to generate adapted simulated voice 232. Processor 210 can generate and output adapted simulated voice 232, in real-time, during a natural language conversation with user 202.

In one embodiment, processor 210 can train neural network 220 using supervised machine learning techniques. Training data that includes ground truth labels can be used for training neural network 220. By way of example, training data being used for training neural network 220 can include training inputs having different user audio input properties and training labels that include prosody and/or style of simulated voices. The supervised machine learning can allow neural network 220 to be trained for inferring a result include audio parameters 224 adapted to specific audio input properties. Therefore, adapted simulated voice 232 can be a simulated voice having prosody and/or style that is considered as relatively more acceptable or preferred by users having voices similar to audio input 204.

In one embodiment, one or more context data 216 can be stored in memory 212. Context data 216 can be digital data representing different contexts, such as specific locations and settings of the conversation between user 202 and voicebot application 218. Processor 210 can be configured to determine a context, such as a location of user 202 and selected one of context data 216 representing the determined location stored in memory 212 to be fed into neural network 220. Neural network 220 can infer the result associated with a plurality of audio parameters 224 based on the properties extracted by processor 210 and based on the context data being inputted by processor 210. By way of example, processor 210 can determine that user 202 is located in a relatively quiet location, such as a library, and an input parameter indicating library being inputted into neural network 220 can cause the outputted audio parameters 224 of the adapted simulated voice 232 to indicate a prosody of a relatively gentle and quiet voice.

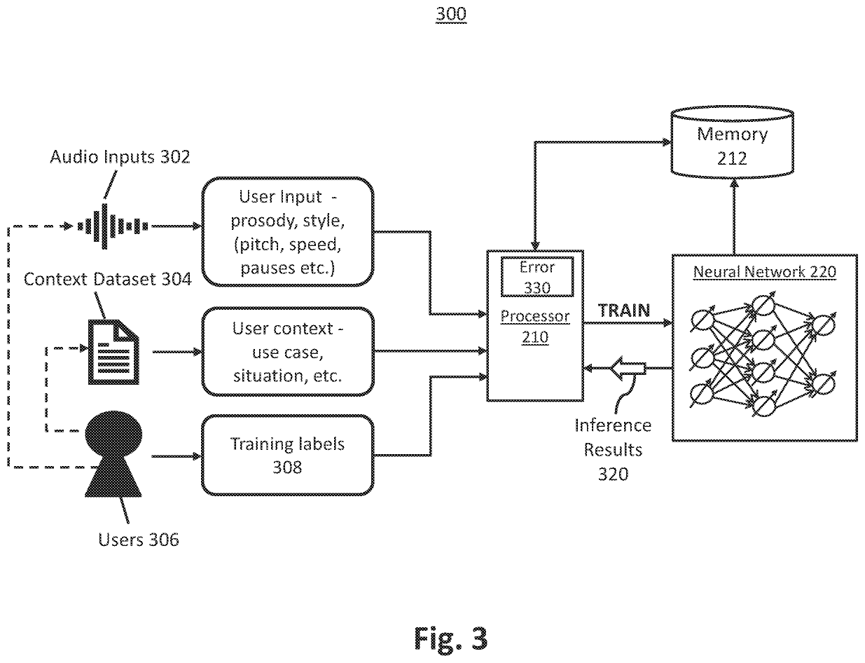

FIG. 3 is a diagram illustrating a system that can train a neural network for implementing adaptive prosody in simulated voice in one embodiment. A neural network training process 300 is shown in FIG. 3. In one embodiment, processor 210 can receive various information from a plurality of users 306 to generate training data for training neural network 220. In an example shown in FIG. 3, users 306 can provide a plurality of audio inputs 302 and context data 304 to processor 210. Users 306 can also provide a plurality of training labels 308 to processor 210.

Audio inputs 302 can include a plurality of analog signals encoding speech or voices of users 306. In one embodiment, processor 210 can output a prompt to users 306 to provide audio inputs 302. By way of example, processor 210 can output a prompt instructing users 306 to speak one or more words, phrases, sentences, questions, or other audio input using different properties such as tones, volume, emotion, pitch, speed, pauses, or other properties. Context data 304 can include context and/or situations such as locations, types of conversations, or the like.

In one embodiment, training labels 308 can be ground truth labels input to processor 210. In one embodiment, processor 210 can provide various types of questions or inquiries, such as in the form of a survey, to users 306 to obtain labels 308. Processor 210 can provide surveys to users 306 asking the type of simulated voices preferred by users 306 under specific context or situations. By way of example, the survey can ask a user among users 306 for a preferred prosody or style of simulated voices when using voicebot application 218 to make medical inquiries, vehicle maintenance inquiries, education inquiries, sales, technical support, or other different types of inquiries.

Processor 210 can receive and use audio inputs 302, context data 304, and training labels 308 for generating training data. The training data can be used for performing supervised machine learning to train neural network 220. In one embodiment, processor 210 can generate training data that maps specific audio input and context data to specific training labels. By way of example, processor 210 can map an audio input having a voice of a student, and a context indicating an educational inquiry, to a training label indicating the student prefers a gentle and quiet voice when answering the educational inquiry. Processor 210 can generate a piece of training data that maps the voice of the student and educational inquiry to gentle and quiet voice.

Processor 210 can continue to receive additional audio inputs 302, context data 304 and training labels 308, generate training data, and feed the training data into neural network 220. During training, neural network 220 can output a plurality of inference results 320, where each prediction can be an inference result from one set of training input and training label. Processor 210 can determine a plurality of errors 330 between inference results 320 and expected inference results. The expected inference results can be training labels 308. Processor 210 can tune a plurality of weights of neural network 220 based on errors 330. Processor 210 can continue to tune the plurality of weights until errors 330 converge to a predefined value, such as a predefined minimum error or zero. The values of weights that caused errors 330 to converge to the predefined value can be optimal values of the plurality of weights. In response to errors 330 converging to the predefined value, processor 210 can set the optimal values of the plurality of weights as final weight values and deploy neural network 220 with the final weight values.

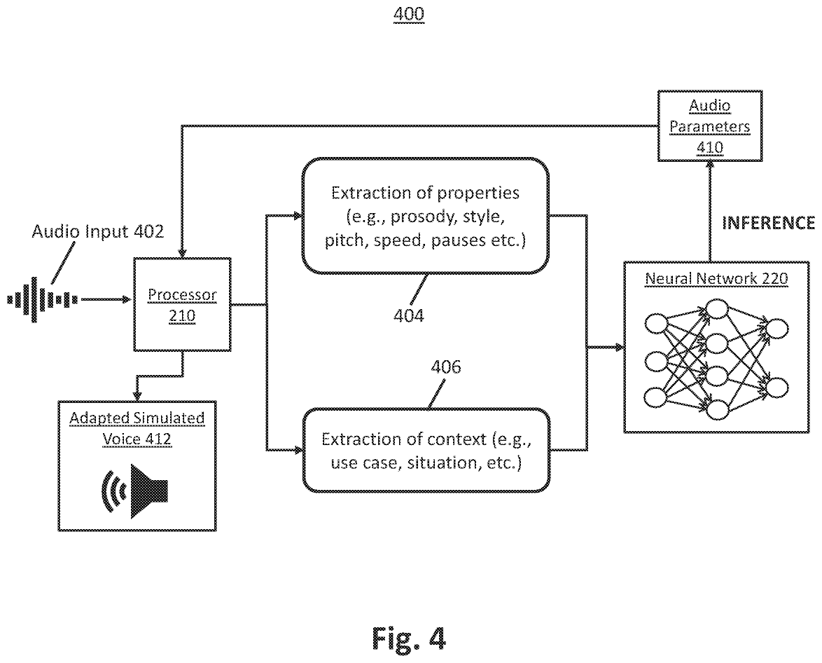

FIG. 4 is a diagram illustrating an inference process for adaptive prosody in simulated voice in one embodiment. An inference process 400 is shown in FIG. 4. In one embodiment, during operation of voicebot application 218 (see FIG. 2), processor 210 can receive an audio input 402 from a user. Processor 210 can perform an extraction 404 to extract one or more properties of audio input 402. In one embodiment, processor 210 can extract the one or more properties by applying classical voice analysis programs that can perform Fourier analysis of audio input and extracting features from a result of the Fourier analysis.

In one embodiment, processor 210 can perform an extraction 406 on audio input 402 to extract context data indicating context such as situation, use case, or other types of context. In one embodiment, extraction 406 can include inputting audio input 402 into a neural network classifier to identify the use case and situation. In one embodiment, processor 210 can also use audio responses being outputted during the operation of voicebot application 218 to perform extraction 406. By way of example, a natural language conversation (“conversation”) can begin between the user providing audio input 402 and voicebot application 218. Processor 210 can output an audio response using a simulated voice with default prosody and style to conduct the conversation. After a lapse of a predefined amount of time (or an exchange of a few audio inputs and audio responses), processor 210 can feed the received audio inputs and outputted audio responses, during the conversation, into a neural network classifier. The neural network classifier can analyze properties, such as utterance, in the audio inputs and the audio responses to identify context such as use case, location, situations, etc. By way of example, audio input 402 can be a medical inquiry including specific medical terms and audio responses can also include medical terms. The neural network classifier can identify these medical terms to determine a use case of medical inquiry.

Processor 210 can feed context data extracted by extraction 406 into neural network 220. Processor 210 can also feed properties extracted by extraction 404 into neural network 220. Neural network can infer a result indicating audio parameters 410. Audio parameters 410 can indicate prosody and/or style of simulated voice that is likely to be preferred or acceptable to the user that provided audio input 402. Processor 210 can generate an adapted simulated voice 412 based on audio parameters 410 and output an audio response using adapted simulated voice 412.

By way of example, neural network 220 may be trained to output audio parameter 410 indicating a particular speaking speed that is same as a speaking speed of a voice in the audio input received by processor 210, under the use case of medical inquiries. Hence, if audio input 402 has a voice with a specific speaking speed and the result from extraction 406 indicates a use case of medical inquiry, neural network 220 can infer audio parameters 410 to indicate the same specific speaking speed. Processor 210 can generate adapted simulated voice 412 using audio parameter 410 such that adapted simulated voice 412 has a same speaking speed as audio input 402.

In one embodiment, processor 210 can be configured to output a plurality of surveys that include relevant use cases and relevant situations within the use cases. Processor 210 can obtain audio inputs 302 from users 306 and measure properties such as prosody parameters including pitch, speed, pauses etc. for each user among users 306. Processor 210 can provide the plurality of surveys to users 306, where the surveys can indicate choices of multiple variants of prosody and speech style parameters of simulated voices. Users 306 can response to the survey, through further audio input or other interfaces such as text, to indicate preference and acceptance of the prosody and speech style in the surveys under different use cases. Processor 210 can rank the preference and acceptance of different prosody and styles under different use cases from users 306. Processor 210 can identify, in the ranked prosody and styles, the prosody and styles with the most positive preferences and acceptances as training labels 308 for training neural network 220.

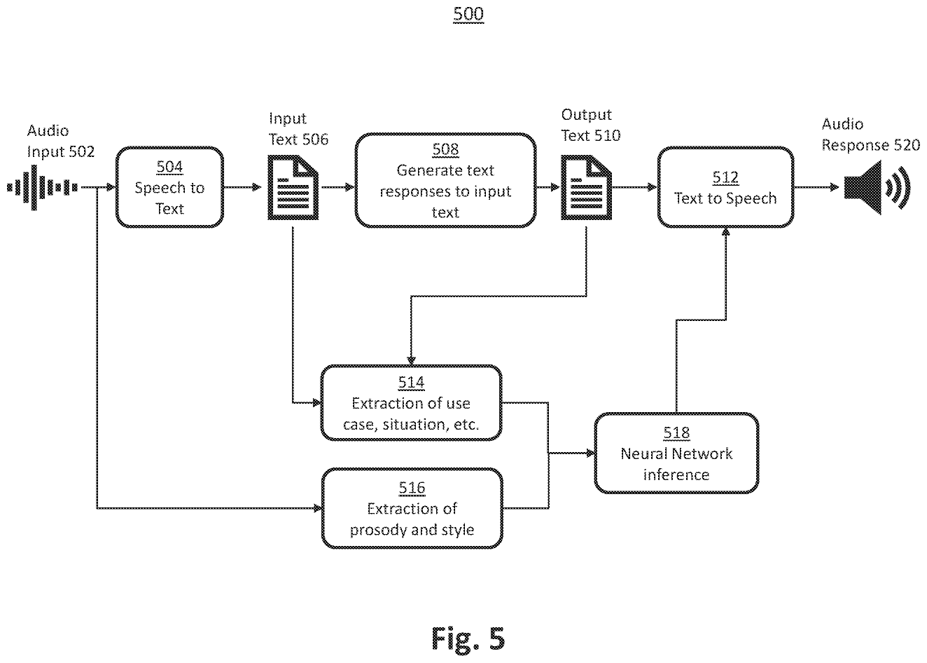

FIG. 5 is a diagram illustrating an example application that can use adaptive prosody in simulated voice in one embodiment. An example application 500 is shown in FIG. 5. In one embodiment, application 500 can be a digital assistant application that can respond to user audio inputs by outputting an audio response using simulated voices. In one embodiment, voicebot application 218 shown in FIG. 2 can be a part of the example application 500 and processor 210 in FIG. 2 to FIG. 4 can be configured to run example application 500.

A processor (e.g., processor 210) can receive an audio input 502. The processor can perform an extraction 516 to identify and extract properties such as prosody and style parameters including at least pitch, speed, pauses, and/or emergent properties from audio input 502. In one embodiment, the processor can identify the property of audio input 502 using a voice analysis program. The voice analysis program can perform Fourier analysis on audio input 502 to extract the properties. The processor can convert audio input 502 into an input text 506. In one embodiment, the processor can apply a speech-to-text technique 504 to convert audio input 502 into input text 506. The processor can generate a text response 508 and output text response 508 as an output text 510. In one embodiment, the processor can generate text response 508 by applying natural language processing techniques on input text 506. The processor can output text response 508 as output text 510. Input text 506 and output text 510 can be data including written text without audio data.

The processor can perform an extraction 514 to extract context data indicating, for example, context, use case, situations, or the like, from input text 506 and output text 510. The processor can input the results from extractions 514, 516 into a neural network (e.g., neural network 220 described herein) to perform neural network inference 518. The processor can perform a text-to-speech technique 512 on output text 510 using audio parameters from neural network inference 518 to generate an audio response 520. Audio response 520 can be outputted as an audio stream that uses a simulated voice having audio parameters inferred from neural network inference 518 to audibly recite output text 510.

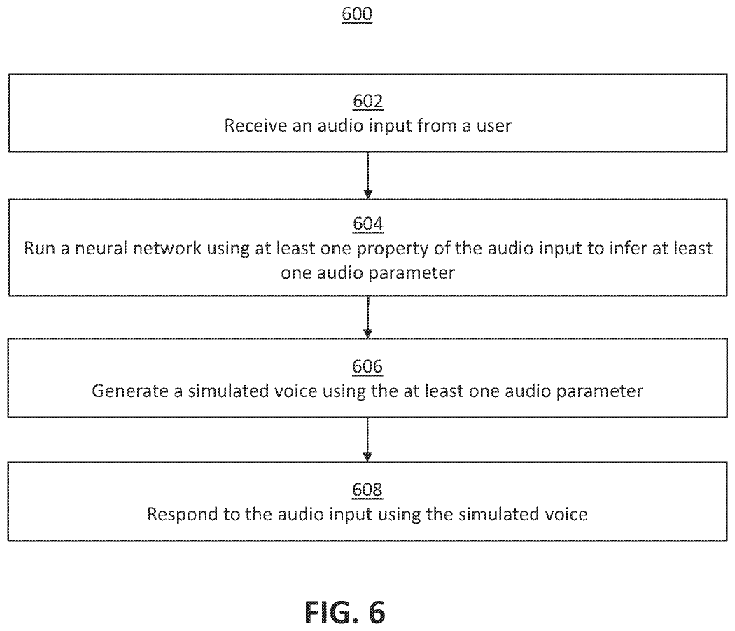

FIG. 6 is a flow diagram illustrating a method of adaptive prosody in simulated voice in one embodiment. The process 600 in FIG. 6 may be implemented using the systems and computing devices discussed above. An example process may include one or more operations, actions, or functions as illustrated by one or more of blocks 602, 604, 606 and/or 608. Although illustrated as discrete blocks, various blocks may be divided into additional blocks, combined into fewer blocks, eliminated, performed in different order, or performed in parallel, depending on the desired implementation.

Process 600 can begin at block 602. At block 602, a processor can receive an audio input from a user. Process 600 can proceed from block 602 to block 604. At block 604, the processor can run a neural network using at least one property of the audio input to infer at least one audio parameter. In one embodiment, the at least one property of the audio input can include at least one of a pitch, a speed, a number of pauses, and a frequency of pauses of the audio input. In one embodiment, the processor can identify the at least one property of the audio input using a voice analysis program to identify the at least one property. In one embodiment, the at least one audio parameter of the simulated voice comprises at least one of a pitch, a speed, a voice style, a number of pauses, and a frequency of pauses of the simulated voice. In one embodiment, the processor can input the at least one property of the audio input into a classifier and obtain, from the classifier, context data that identifies the context of the audio conversation.

Process 600 can proceed from block 604 to block 606. At block 606, the processor can generate a simulated voice using the at least one audio parameter. Process 600 can proceed from block 606 to block 608. At block 608, the processor can respond to the audio input using the simulated voice. In one embodiment, the processor can convert the audio input into a text input. The processor can generate a text response to the text input. The processor can extract context data from the text input and the text response. The processor input the context data and the at least one property of the audio input into the neural network infer the at least one audio parameter. The processor can convert the text response into an audio response having the simulated voice.

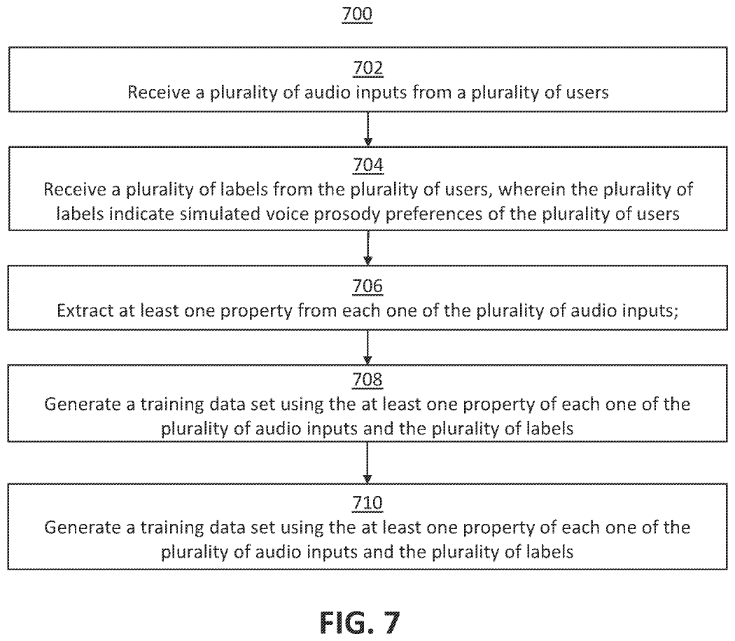

FIG. 7 is another flow diagram illustrating a method of adaptive prosody in simulated voice in one embodiment. The process 700 in FIG. 7 may be implemented using the systems and computing devices discussed above. An example process may include one or more operations, actions, or functions as illustrated by one or more of blocks 702, 704, 706, 708 and/or 710. Although illustrated as discrete blocks, various blocks may be divided into additional blocks, combined into fewer blocks, eliminated, performed in different order, or performed in parallel, depending on the desired implementation.

Process 700 can begin at block 702. At block 702, a processor can receive a plurality of audio inputs from a plurality of users. Process 700 can proceed from block 702 to block 704. At block 704, the processor can receive a plurality of labels from the plurality of users. The plurality of labels can indicate simulated voice prosody preferences of the plurality of users. In one embodiment, the simulated voice prosody preferences can include indications of at least one of a pitch, a speed, a voice style, a number of pauses, and a frequency of pauses of the simulated voice.

Process 700 can proceed from block 704 to block 706. At block 706, the processor can extract at least one property from each one of the plurality of audio inputs. In one embodiment, the at least one property of the audio input comprises at least one of a pitch, a speed, a number of pauses, and a frequency of pauses of the audio input.

Process 700 can proceed from block 706 to block 708. At block 708, the processor can generate a training data set using the at least one property of each one of the plurality of audio inputs and the plurality of labels. In one embodiment, the processor can receive context data from the plurality of users and generate the training data set using the context data, the at least one property of each one of the plurality of audio inputs and the plurality of labels.

Process 700 can proceed from block 708 to block 710. At block 710, the processor can train a neural network using the training data set. In one embodiment, the processor can tune a plurality of weights of the neural network until an error of the neural network converges to a predefined value. In response to the error converging to the predefined value, the processor can deploy the neural network. In one embodiment, the processor can deploy the neural network to a voicebot application.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, run concurrently, substantially concurrently, in a partially or wholly temporally overlapping manner, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”. “including”, and/or “having.” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
receiving, by a processor, an audio input from a user;
running, by the processor, a neural network using at least one property of the audio input to infer at least one audio parameter;
generating, by the processor, a simulated voice using the at least one audio parameter; and
responding, by the processor, to the audio input using the simulated voice.

2. The computer-implemented method of claim 1, wherein the at least one property of the audio input comprises at least one of a pitch, a speed, a number of pauses, and a frequency of pauses of the audio input.

3. The computer-implemented method of claim 1, further comprising identifying the at least one property of the audio input using a voice analysis program to identify the at least one property.

4. The computer-implemented method of claim 1, wherein the at least one audio parameter of the simulated voice comprises at least one of a pitch, a speed, a voice style, a number of pauses, and a frequency of pauses of the simulated voice.

5. The computer-implemented method of claim 1, further comprising:
inputting the at least one property of the audio input into a classifier; and
obtaining, from the classifier, context data that identifies the context of the audio input.

6. The computer-implemented method of claim 1, further comprising:
converting, by the processor, the audio input into a text input;
generating, by the processor, a text response to the text input;
extracting, by the processor, context data from the text input and the text response;
inputting, by the processor, the context data and the at least one property of the audio input into the neural network to infer the at least one audio parameter; and
converting, by the processor, the text response into an audio response having the simulated voice.

7. The computer-implemented method of claim 1, further comprising:
receiving, by a processor, a plurality of training audio inputs from a plurality of users;
receiving, by the processor, a plurality of labels from the plurality of users, wherein the plurality of labels indicate simulated voice prosody preferences of the plurality of users;
extracting, by the processor, at least one property from each one of the plurality of training audio inputs;
generating, by the processor, a training data set using the at least one property of each one of the plurality of training audio inputs and the plurality of labels; and
training, by the processor, the neural network using the training data set.

8. The computer-implemented method of claim 7, further comprising:
tuning, by the processor, a plurality of weights of the neural network until an error of the neural network converges to a predefined value; and
in response to the error converging to the predefined value, deploying the neural network.

9. The computer-implemented method of claim 8, wherein deploying the neural network comprises deploying the neural network to a voicebot application.

10. A system comprising:
a memory configured to store a plurality of weights of a neural network;
a processor configured to:
receive an audio input from a user;
run the neural network using at least one property of the audio input to infer at least one audio parameter;
generate a simulated voice using the at least one audio parameter; and
respond to the audio input using the simulated voice.

11. The system of claim 10, wherein the at least one property of the audio input comprises at least one of a pitch, a speed, a number of pauses, and a frequency of pauses of the audio input.

12. The system of claim 10, wherein the processor is configured to identify the at least one property of the audio input using a voice analysis program to identify the at least one property.

13. The system of claim 10, wherein the at least one audio parameter of the simulated voice comprises at least one of a pitch, a speed, a voice style, a number of pauses, and a frequency of pauses of the simulated voice.

14. The system of claim 10, wherein the processor is configured to:
input the at least one property of the audio input into a classifier; and
obtain, from the classifier, context data that identifies the context of the audio input.

15. The system of claim 10, wherein the processor is configured to:
convert the audio input into a text input;
generate a text response to the text input;
extract context data from the text input and the text response;
input the context data and the at least one property of the audio input into the neural network to infer the at least one audio parameter; and
convert the text response into an audio response having the simulated voice.

16. The system of claim 10, wherein the processor is configured to:
receive a plurality of training audio inputs from a plurality of users;
receive a plurality of labels from the plurality of users, wherein the plurality of labels indicates simulated voice prosody preferences of the plurality of users;
extract at least one property from each one of the plurality of training audio inputs;
generate a training data set using the at least one property of each one of the plurality of training audio inputs and the plurality of labels; and
train the neural network using the training data set.

17. The system of claim 16, wherein the processor is configured to:
tune a plurality of weights of the neural network until an error of the neural network converges to a predefined value; and
in response to the error converging to the predefined value, deploy the neural network.

18. A computer program product comprising a computer readable storage medium having program instructions embodied therewith, the program instructions readable by a device to cause the device to:
receive an audio input from a user;
run a neural network using at least one property of the audio input to infer at least one audio parameter;
generate a simulated voice using the at least one audio parameter; and
respond to the audio input using the simulated voice.

19. The computer program product of claim 9, wherein the device is further caused to:
convert the audio input into a text input;
generate a text response to the text input;
extract context data from the text input and the text response;
input the context data and the at least one property of the audio input into the neural network to infer the at least one audio parameter; and
convert the text response into an audio response having the simulated voice.

20. The computer program product of claim 9, wherein the device is further caused to:
receive a plurality of training audio inputs from a plurality of users;
receive a plurality of labels from the plurality of users, wherein the plurality of labels indicates simulated voice prosody preferences of the plurality of users;
extract at least one property from each one of the plurality of training audio inputs;
generate a training data set using the at least one property of each one of the plurality of training audio inputs and the plurality of labels; and
train the neural network using the training data set.
